(19) United States
(12) Patent Application Publication
(10) Pub. No.: US 2019/0042979 A1
(43) Pub. Date: Feb. 7, 2019

(54) THERMAL SELF-LEARNING WITH REINFORCEMENT LEARNING AGENT

(71) Applicant: Intel Corporation, Santa Clara, CA (US)

(72) Inventors: Raghuveer Devulapalli, Hillsboro, OR (US); Kelly Hammond, Hillsboro, OR (US); Yonghong Huang, Portland, OR (US); Srinivas Pandruvada, Beaverton, OR (US); Rahul Unnikrishnan Nair, Hillsboro, OR (US); Arjan Van De Ven, Portland, OR (US); Denis Vladimirov, Hillsboro, OR (US); Qin Wang, Beaverton, OR (US)

(21) Appl. No.: 16/021,704

(22) Filed: Jun. 28, 2018

(51) Int. Cl. G06N 99/00; G05B 19/406

(52) U.S. Cl. CPC G06N 99/005; G05B 2219/49206; G05B 19/406

(57) ABSTRACT

An embodiment of a semiconductor package apparatus may include technology to learn thermal behavior information of a system based on input information including one or more of processor information, thermal information, and cooling information, and provide information to adjust one or more of a parameter of a processor and a parameter of a cooling subsystem based on the learned thermal behavior information and the input information. Other embodiments are disclosed and claimed.

### TECHNICAL FIELD

Embodiments generally relate to thermal management systems. More particularly, embodiments relate to thermal self-learning with a reinforcement learning agent.

### BACKGROUND

For many computer systems, efficient cooling solutions are important to ensure high system performance. Thermal cooling may include passive cooling and active cooling. Active cooling may include fans, heat sinks or other heat transfer components which dissipate heat. Passive cooling includes soft cooling technology to curb the CPU frequency (e.g., or power) to reduce the heat produced. Active cooling involves air cooling (e.g., running a fan to dissipate the heat generated into the environment), liquid cooling (e.g., running a pump to circulate a liquid to dissipate the heat), etc.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an electronic processing system according to an embodiment;

FIG. 2 is a block diagram of an example of a semiconductor package apparatus according to an embodiment;

FIGS. 3A to 3B are flowcharts of an example of a method of managing a thermal system according to an embodiment;

FIGS. 4A to 4B are block diagrams of examples of another electronic processing system apparatus according to an embodiment;

FIGS. 5A to 5B are block diagrams of examples of another electronic processing system apparatus according to an embodiment;

FIGS. 6A and 6B are block diagrams of examples of thermal management apparatuses according to embodiments;

FIG. 7 is a block diagram of an example of a processor according to an embodiment; and

FIG. 8 is a block diagram of an example of a system according to an embodiment.

### DESCRIPTION OF EMBODIMENTS

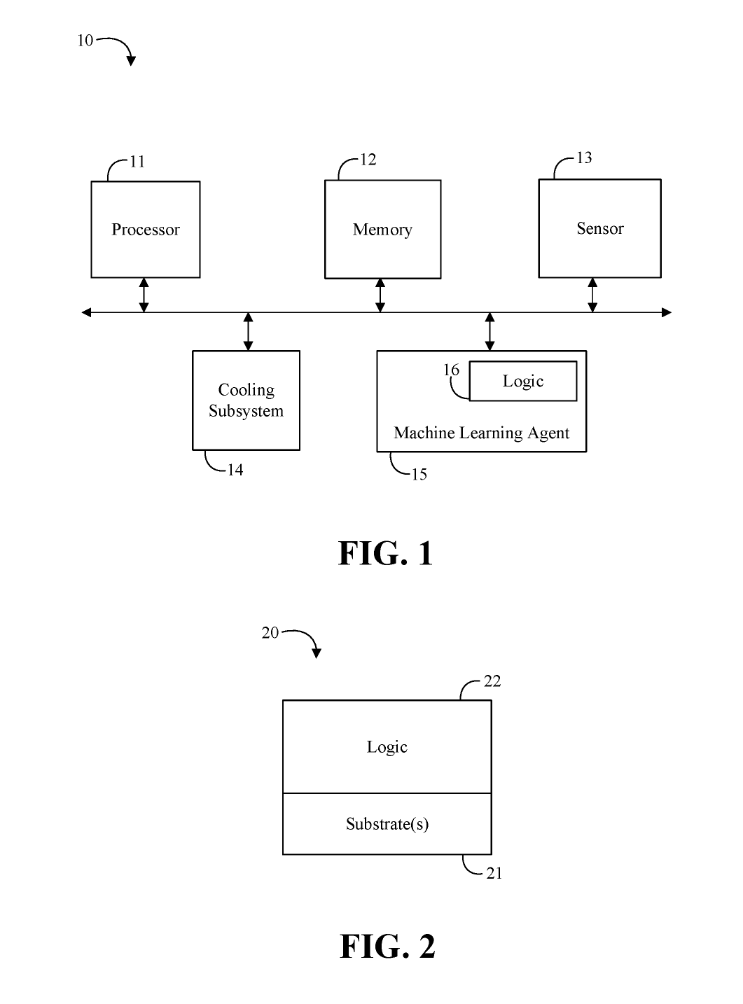

Turning now to FIG. 1, an embodiment of an electronic processing system 10 may include a processor 11, memory 12 communicatively coupled to the processor 11, a sensor 13 (e.g., a thermal sensor, an airflow sensor, a power sensor, an activity sensor, etc.) communicatively coupled to the processor 11, a cooling subsystem 14 (e.g., including passive and/or active cooling components) communicatively coupled to the processor 11, and a machine learning agent 15 communicatively coupled to the processor 11, the sensor 13, and the cooling subsystem 14. The machine learning agent may include logic 16 to learn thermal behavior information of the system based on information from one or more of the processor 11, the sensor 13, and the cooling subsystem 14, and adjust one or more of a parameter of the processor 11 (e.g., power, frequency, utilization, etc.) and a parameter of the cooling subsystem 14 (e.g., power, fan speed, pump throughput, air restriction, etc.) based on the learned thermal behavior information and information from one or more of the processor 11, the sensor 13, and the cooling subsystem 14. In some embodiments, the logic 16 may be configured to learn the thermal behavior information of the system 10 based on reinforcement information from one or more of the processor 11, the sensor 13, and the cooling subsystem 14. For example, the reinforcement information may include one or more of reward information and penalty information.

In some embodiments, the logic 16 may be further configured to learn the thermal behavior of the system 10 based on adjustments to increase the reward information and decrease the penalty information. For example, increased reward information may correspond to one or more of increased processor frequencies and reduced active cooling, and increased penalty information may correspond to processor temperatures above a threshold temperature. In some embodiments, the machine learning agent 15 may include a deep reinforcement learning agent with Q-learning (e.g., where “Q” may refer to action-value pairs, or an action-value function). In some embodiments, the machine learning agent 15 and/or the logic 16 may be located in, or co-located with, various components, including the processor 11 (e.g., on a same die).

Embodiments of each of the above processor 11, memory 12, sensor 13, cooling subsystem 14, machine learning agent 15, logic 16, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof. Embodiments of the processor 11 may include a general purpose processor, a special purpose processor, a central processor unit (CPU), a controller, a micro-controller, etc.

Alternatively, or additionally, all or portions of these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, the memory 12, persistent storage media, or other system memory may store a set of instructions which when executed by the processor 11 cause the system 10 to implement one or more components, features, or aspects of the system 10 (e.g., the machine learning agent 15, the logic 16, learning the thermal behavior information of the system, and adjusting the parameter(s) of the processor and/or the parameter(s) of the cooling subsystem based on the learned thermal behavior information, etc.).

Turning now to FIG. 2, an embodiment of a semiconductor package apparatus 20 may include one or more substrates 21, and logic 22 coupled to the one or more substrates 21, wherein the logic 22 is at least partly implemented in one or more of configurable logic and fixed-functionality hardware logic. The logic 22 coupled to the one or more substrates 21 may be configured to learn thermal behavior information of a system based on input information including one or more of processor information, thermal information, and cooling information, and provide information to adjust one or more of a parameter of a processor (e.g., power, frequency, utilization, etc.) and a parameter of a cooling subsystem (e.g., power, fan speed, pump throughput, air restriction, etc.) based on the learned thermal behavior information and the input information. In some embodiments, the input information may include reinforcement information, and the logic 22 may be further configured to learn the thermal behavior information of the system based on the reinforcement information. For example, the reinforcement information may include one or more of reward information and penalty information. In some embodiments, the logic 22 may be configured to learn the thermal behavior of the system based on adjustments to increase the reward information and decrease the penalty information. For example, increased reward information may correspond to one or more of increased processor frequencies and reduced active cooling, and increased penalty information may correspond to processor temperatures above a threshold temperature. In some embodiments, the logic 22 may be further configured to provide a deep reinforcement learning agent with Q-learning. In some embodiments, the logic 22 coupled to the one or more substrates 21 may include transistor channel regions that are positioned within the one or more substrates 21.

Embodiments of logic 22, and other components of the apparatus 20, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

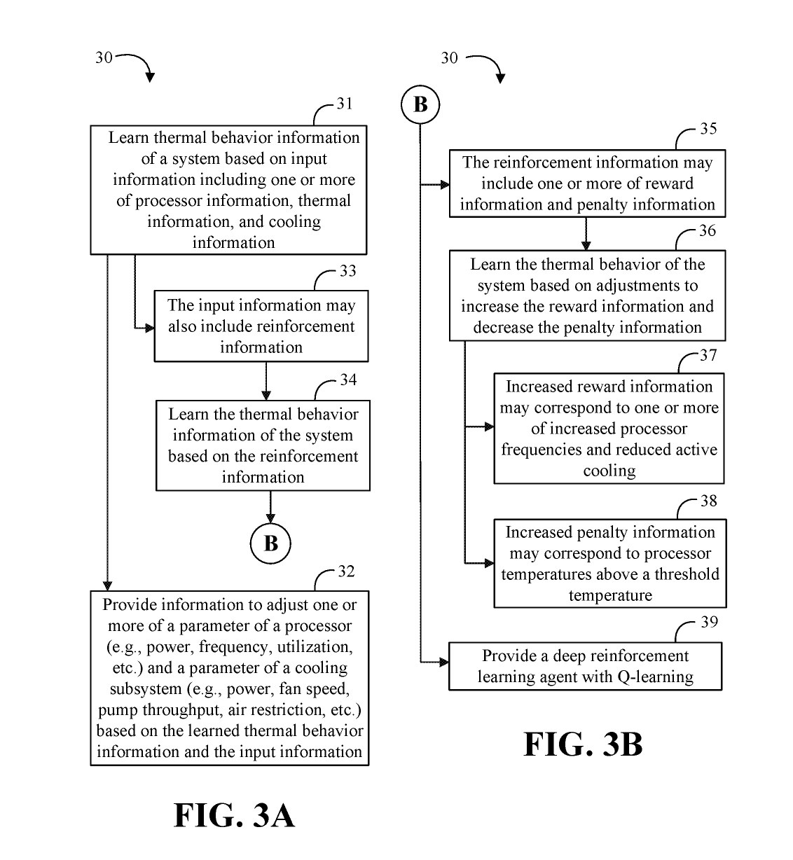

The apparatus 20 may implement one or more aspects of the method 30 (FIGS. 3A to 3B), or any of the embodiments discussed herein. In some embodiments, the illustrated apparatus 20 may include the one or more substrates 21 (e.g., silicon, sapphire, gallium arsenide) and the logic 22 (e.g., transistor array and other integrated circuit/IC components) coupled to the substrate(s) 21. The logic 22 may be implemented at least partly in configurable logic or fixed-functionality logic hardware. In one example, the logic 22 may include transistor channel regions that are positioned (e.g., embedded) within the substrate(s) 21. Thus, the interface between the logic 22 and the substrate(s) 21 may not be an abrupt junction. The logic 22 may also be considered to include an epitaxial layer that is grown on an initial wafer of the substrate(s) 21.

Turning now to FIGS. 3A to 3B, an embodiment of a method 30 of managing a thermal system may include learning thermal behavior information of a system based on input information including one or more of processor information, thermal information, and cooling information at block 31, and providing information to adjust one or more of a parameter of a processor (e.g., power, frequency, utilization, etc.) and a parameter of a cooling subsystem (e.g., power, fan speed, pump throughput, air restriction, etc.) based on the learned thermal behavior information and the input information at block 32. In some embodiments, the input information may also include reinforcement information at block 33, and the method 30 may include learning the thermal behavior information of the system based on the reinforcement information at block 34. For example, the reinforcement information may include one or more of reward information and penalty information at block 35. Some embodiments of the method 30 may further include learning the thermal behavior of the system based on adjustments to increase the reward information and decrease the penalty information at block 36. For example, increased reward information may correspond to one or more of increased processor frequencies and reduced active cooling at block 37, and increased penalty information may correspond to processor temperatures above a threshold temperature at block 38. Some embodiments of the method 30 may further include providing a deep reinforcement learning agent with Q-learning at block 39.

Embodiments of the method 30 may be implemented in a system, apparatus, computer, device, etc., for example, such as those described herein. More particularly, hardware implementations of the method 30 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 30 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the method 30 may be implemented on a computer readable medium as described in connection with Examples 20 to 25 below. Embodiments or portions of the method 30 may be implemented in firmware, applications (e.g., through an application programming interface (API)), or driver software running on an operating system (OS). Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Some embodiments may advantageously provide an adaptive self-learning solution for active and passive CPU thermal cooling using reinforcement learning and/or modeling technology. As noted above, efficient CPU cooling solutions may be important to ensure high system performance. In some systems, passive cooling may control the CPU frequency (e.g., or power) to reduce the heat produced, and active cooling may involve running a fan to dissipate the heat generated into the environment. Passive cooling may reduce the system performance, while fans may consume power and may be noisy to operate. In some systems, it may be important that the cooling solution finds the right balance between power and performance while ensuring that the CPU operates within the designed thermal limits. High performance computing in small factor devices may include an increased number of cores and clock speeds, which may drive up power consumption and lead to excessive heat generated by the CPU. This heat needs to be effectively dissipated in order to keep the system and the CPU within safe operating conditions. Passive cooling technology may control the CPU frequency, CPU idle states, and/or power consumption, which may limit how much CPU heat is generated. Active cooling devices (like heat pumps and fan) may transfer the generated heat from the device to the environment. The parameters needed for efficient cooling may depend on many things, from environmental factors (e.g., air temperature, air pressure/altitude, exact layout of the machines cooling solution, air flow, age of the fan, amount of dust in the fan/cooling block, etc.) to workload factors (e.g., games versus web browsing versus office applications etc.).

Some conventional cooling policies may be considered as reactive solutions that use a set of temperature trip points to trigger a predefined cooling actions. Determining suitable trip points and corresponding actions may be complex and typically the set points may be approximations established from thermal experiments, user experiences, or community knowledge. To ensure that the CPU does not hit critical limits, the set points may be overly aggressive which either reduces performance, consumes more power, or both. Additionally, the set points may be static in the sense that they remain constant throughout the life cycle of the system and hence, do not adapt to varying operating conditions (e.g., ambient temperature, air pressure, aging components, collection of dust, etc.).

Some conventional cooling solutions may be based on heuristic solutions that are predefined and static configurations that are put in place when the system is first shipped to the end user. The configuration may be a static, sub-optimal solution designed for average or worst-case scenario and does not adapt to changing operating conditions. The configuration may not scale well across devices and may require re-designing the cooling solution for each device/platform independently. In some cases, the end user may modify these configurations by editing a file, but it is not a trivial task to come up with an optimal configuration. For example, editing the configuration file appropriately may require in depth knowledge about the thermal properties of the system, which may be beyond the scope of an average end user. Some conventional cooling solutions may be considered reactive technology, where the cooling solutions kicks only when the system hits a set or critical point. Such reactive technology may lead to thermal throttling where a significant drop in performance occurs.

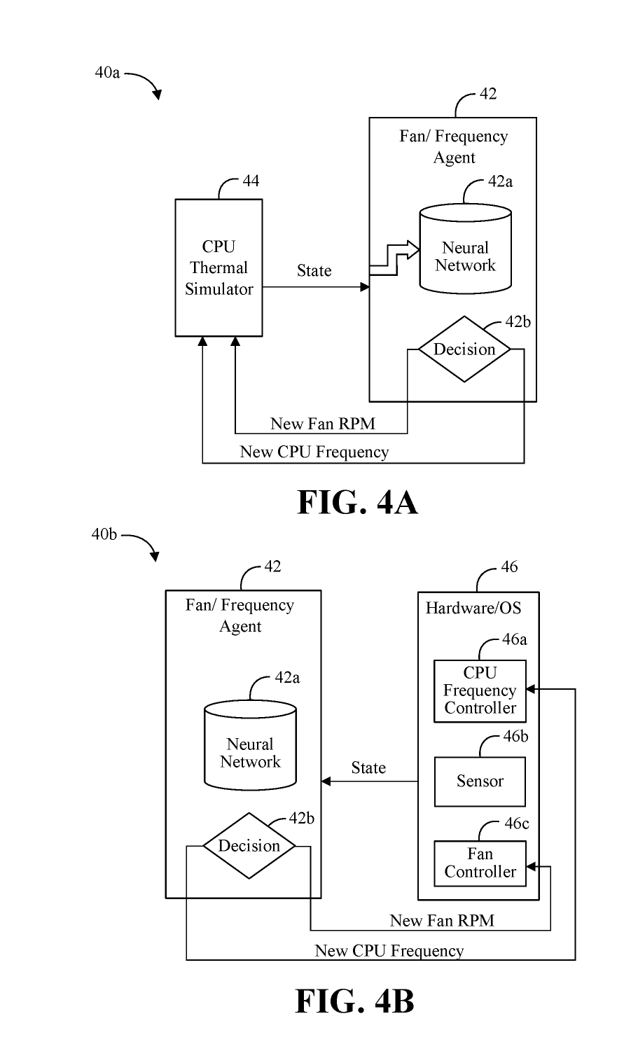

Turning now to FIGS. 4A to 4B, an embodiment of an electronic processing system may include a training system 40a (FIG. 4A) and a deployed system 40b (FIG. 4B). In the training phase, the system 40a may include a machine learning agent 42 coupled to a CPU thermal simulator 44. The machine learning agent 42 may include a neural network 42a (e.g., and/or other suitable machine learning technology). The machine learning agent 42 may receive input information from the CPU thermal simulator 44 including state information such as CPU frequency information, CPU utilization information, CPU temperature information, fan revolutions-per-minute (RPM) information, etc. The neural network 42a may process the input information and create a decision network 42b which outputs a recommended new fan RPM and a recommended new CPU frequency to the CPU thermal simulator 44. Alternatively, some embodiments of the training system 40a may utilize a real system in place of the CPU thermal simulator 44. For the agent 42 to learn about the system 40a, the agent 42 may go through a learning or exploration stage where, for example, the agent 42 may collect supervised data from the CPU on a real system to learn about the CPU thermal behavior under stress. The agent 42 may use this data to build a supervised model. After the agent 42 has built a supervised model, the agent 42 may start to take actions based on the learned behavior.

After the training phase has sufficiently progressed (e.g., the agent 42 has converged to a policy), in the deployed system 40b the agent 42 may be coupled to a physical hardware platform 46 (e.g., see FIG. 4B). The platform 46 may include hardware and an OS, a CPU frequency controller 46a, a sensor 46b, a fan controller 46c, etc. The platform 46 may provide information to the agent 42 corresponding to the current state (e.g., CPU frequency from the CPU frequency controller 46a, the current CPU utilization, the current CPU temperature from the sensor 46b, the current fan RPM from the fan controller 46c, etc.). The agent 42 may process the input information with the neural network 42a and the decision network 42b may output a recommended new fan RPM to the fan controller 46c, and a recommended new CPU frequency to the CPU frequency controller 46a.

The process of the agent 42 exploring various actions on the environment on a real system (e.g., deployed system 40b in FIG. 4B) may have various problems including, for example, that an extreme action or inaction by the agent may critically damage the platform 46, and the initial training may be time consuming because this the training may be done in real time (e.g., where the agent 42 has to wait for the environment to respond). Advantageously, a supervised thermal model of the CPU may be built (e.g., the CPU thermal simulator 44 in FIG. 4A) and used to train the agent 42 on the model first before the agent 42 is deployed to run on the platform 46 (e.g., see FIG. 4B).

Some embodiments may advantageously provide a reinforcement learning based thermal cooling solution, where cooling software (e.g., an agent) may automatically learn the system's thermal behavior by interacting with the CPU. The agent may learn to take better or optimal actions based on rewards and/or penalty information the agent receives from the host system. With suitable reward functions, some embodiments may control various parameters such as CPU frequency and fan speed to proactively prevent the system from exceeding the thermal boundaries while optimizing for power and performance. Some embodiments may provide an improved or optimal cooling solution that may be proactive and requires little or no user intervention (e.g., adapting over time as the system/components age). Some embodiments may help reduce or prevent CPU frequency throttling in performance mode and may also save battery life in a power saving mode. Some embodiments may provide a robust thermal solution that may adapt well to changing operating conditions and may be scalable across different type of hardware problems (e.g., more efficiently than conventional solutions).

Some systems may exhibit a thermal behavior where the CPU temperature remains relatively constant after some threshold fan speed. For example, at any fan speed above a certain threshold, further increases in the fan speed may be ineffective in reducing the CPU temperature. Conventional solutions may not be able to adapt to this behavior and may aggressively run the fan at maximum speeds for the higher CPU temperatures. Unnecessarily running a motor based fan at higher speeds not only makes the fan noisier but also consumes unnecessary power (e.g., which may further drain the battery of a laptop). Some embodiments may advantageously learn the thermal behavior of the system and avoid high fan speed when the high fan speed is ineffective.

Some embodiments may provide a reinforcement learning based solution that may be applied to a wide variety of thermal behaviors/problems. Some embodiments may learn about the system's thermal behavior and use the learned information to apply improved or optimal cooling policies. Some embodiments of a cooling solution with reinforcement learning technology may advantageously scale across different platforms with little or no changes. Some embodiments may adapt to changing environments, learning improved or optimal cooling policies continuously over time. Some embodiments may require no or minimal user intervention.

Reinforcement Learning Based Cooling Examples

Some embodiments of thermal cooling solution may be based on artificial intelligence technology for adaptive control, which in some embodiments may be referred to as reinforcement learning. In some embodiments of reinforcement learning technology, for example, an agent may automatically determine an improved or ideal active and passive cooling policy based on rewards and/or penalty information the agent receives while continuously interacting with the environment. Any suitable reinforcement learning technology may be utilized, and may be similar to reinforcement learning technology which has been applied in various fields such as for example, game theory, robotics, games, operations research, control theory, etc. When applying reinforcement learning technology to manage the thermals of the CPU, some embodiments of the agent may be implemented as thermal cooling software, and the environment is the CPU (e.g., which may provide the reinforcement information including reward/penalty information).

In some embodiments, the agent may observe the state of the CPU (e.g., temperature, frequency, CPU utilization, etc.), and periodically (e.g., at every time step) decide to take an action (e.g., which may include changing the fan speed (active cooling), and/or limiting the CPU frequency (passive cooling)). For every action the agent takes, the environment may move to a new state and return a reward/penalty which indicates how good or bad the action is. A policy may specify an action the agent has to take when in a particular state, and the goal of the agent may be to learn a good or optimal policy across all states by maximizing the long term rewards the agent receives. By designing appropriate reward functions, some embodiments may teach the agent how to keep the CPU within safe thermal environments while maximizing performance.

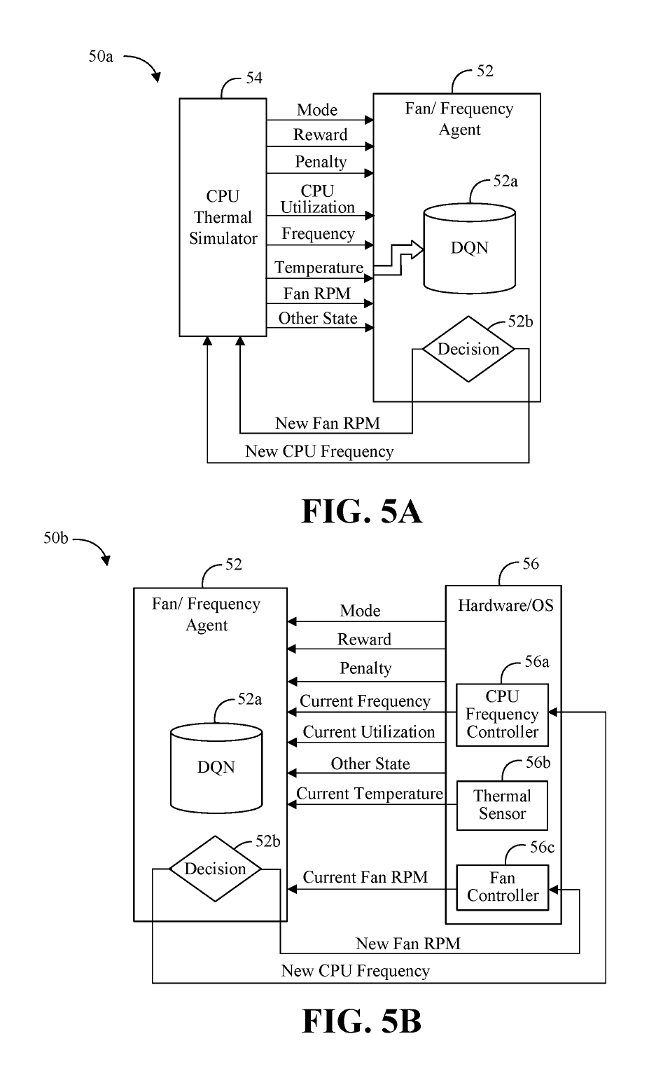

Turning now to FIGS. 5A to 5B, an embodiment of an electronic processing system may include a training system 50a (FIG. 5A) and a deployed system 50b (FIG. 5B). In the training phase, the system 50a may include a reinforcement learning (RL) agent 52 coupled to a CPU thermal simulator 54. The RL agent 52 may include a deep-Q neural network (DQN) 52a (e.g., and/or other suitable machine learning technology). The RL agent 52 may receive input information from the CPU thermal simulator 54 such as CPU frequency information, CPU utilization information, CPU temperature information, fan RPM information, and/or other state information. The RL agent 52 may also receive input information related to a power mode (e.g., performance mode, normal mode, power saving mode, etc.), reward information, and/or penalty information. The reward and/or penalty information may be different between the various power modes to encourage the RL agent 52 to adopt different policies based on the power mode. The DQN 52a may process the input information and create a decision network 52b which outputs a recommended new fan RPM and a recommended new CPU frequency to the CPU thermal simulator 54. For the RL agent 52 to learn about the system 50a, the RL agent 52 may go through a learning or exploration stage where, for example, the RL agent 52 may take actions at random and learn via the input information the RL agent 52 receives from the CPU thermal simulator 54. After the RL agent 52 has explored many or all actions and converged to a policy, the exploration phase may be gradually phased out to an exploitation phase, where the RL agent 52 may take actions based on the optimum policy the RL agent 52 has learned.

After the training phase has sufficiently progressed (e.g., the RL agent 52 has converged to a policy), in the deployed system 50b the RL agent 52 may be coupled to a physical hardware platform 56 (e.g., see FIG. 5B). The platform 56 may include hardware and an OS, a CPU frequency controller 56a, a thermal sensor 56b, a fan controller 56c, etc. The platform 56 may provide information to the RL agent 52 corresponding to the current CPU frequency (e.g., from the CPU frequency controller 56a), the current CPU temperature (e.g., from the thermal sensor 56b), and the current fan RPM (e.g., from the fan controller 56c). The platform 56 may also provide information to the RL agent 52 related to a current power mode, current reward information, and/or current penalty information. The RL agent 52 may process the input information with the DQN 52a and the decision network 52b may output a recommended new fan RPM to the fan controller 56c, and a recommended new CPU frequency to the CPU frequency controller 56a.

For the RL agent 52 to learn about the system 50a, the RL agent 52 may go through a learning or exploration stage, where the RL agent 52 may take actions at random and learn via the rewards the RL agent 52 receives from the environment (e.g., the CPU thermal simulator 54). The RL agent 52 first learns from simulated training (FIG. 5A) and then applies the learned policy on the real system (FIG. 5B). After the RL agent 52 has explored all or most actions and converged to a policy, the exploration phase may be gradually phased out to an exploitation phase, where the RL agent 52 may then take actions based on the optimum policy the RL agent 52 has learned. Any suitable techniques may be utilized to train the RL agent 52 including, for example, deep reinforcement learning with Q-learning. As discussed above, performing the initial training of the RL agent 52 on the training system 50a may avoid damage to the system 50b while the RL agent 52 learns an initial policy. Alternatively, some embodiments may perform the training on a real system in place of the CPU thermal simulator 54 (e.g., taking some other steps to avoid damage).

Supervised Learning/Model Based Examples

Factors like CPU power, fan speed, ambient temperature, etc. may directly influence the CPU temperature. The exact relationship between these variables may depend on many other parameters (e.g., CPU specification, heat sink, thermal paste, etc.) and may vary from device to device. Some embodiments may build a good statistical model by collecting labeled data on the actual device. For example, many devices come with one or more built-in sensors that report CPU temperature and fan speed. By running several benchmark workloads and stressing the CPU, some embodiments may collect the labeled data and build a reasonably representative thermal model of the CPU. For example, the model may include a maximum attainable CPU temperature as a function of CPU power (e.g., which may depend on CPU frequency and utilization) and fan speed, assuming that ambient temperature is held constant at 25 degrees Celsius. In some embodiments, the model may predict the maximum temperature of the CPU based on the current operating conditions.

Some embodiments may teach two different agents to control the CPU temperature. The first agent may learn to set improved or optimal fan speeds (e.g., active cooling) and may not influence the CPU frequency at all. The second agent may learn to control the CPU frequency while the fan speed is kept constant (e.g., passive cooling only). For both of the agents, a DQN network may utilize a fully connected traditional neural network. The agents may be trained on simulated thermal model of a target platform and the hyper parameters of the networks may be tuned to ensure convergence of the agent's policy (e.g., based on a few experimental runs). In some cases, the initial learning may also happen on a physical system as well. Following the initial learning, the trained agent may be applied to a real physical system. Advantageously, the agent may be easily ported from, for example, a LINUX platform to an ANDROID automotive platform.

The passive cooling RL agent may learn to control the CPU frequency to keep the temperature below a specified limit (e.g., 70 degrees Celsius) with little or no effect on performance. The agent may receive rewards for increasing frequency (e.g., the higher the frequency, the higher the reward) and the agent may be penalized if the CPU temperature exceeded the specified limit. The passive cooling RL agent may initially explore different actions and try all the possible frequency settings. After a number of reinforced learning steps, the passive cooling RL agent may learn to select an action that maximizes the CPU frequency while maintaining the CPU temperature below the specified limit (e.g., or a set critical point).

The active cooling RL agent may learn to control the fan speed. The active cooling RL agent may be rewarded for lower fan speeds and penalized for exceeding the specified temperature limit (e.g., a critical temperature of 70 degrees Celsius). The active cooling RL agent may initially learn improved or optimal fan speeds on a simulated system to achieve the desired objective. After learning the policy on the model, the active cooling RL agent may be ported to a physical system to control the fan on real workloads. Advantageously, the active cooling RL agent may take the temperature under control immediately and then keep the CPU temperature at the desired temperature.

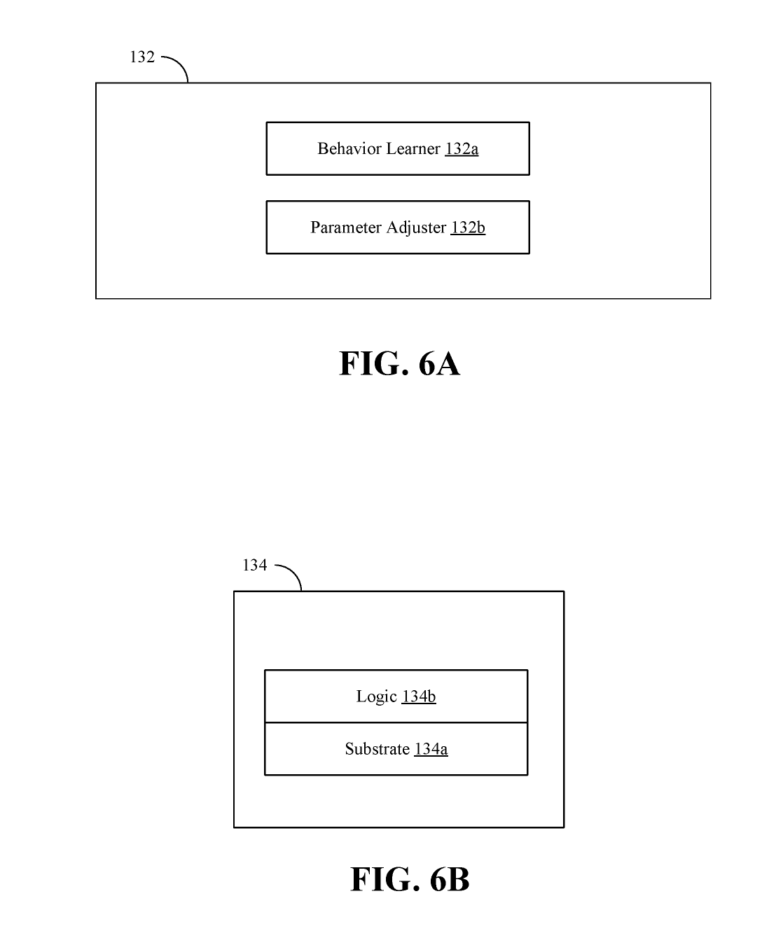

FIG. 6A shows a thermal management apparatus 132 (132a-132b) that may implement one or more aspects of the method 30 (FIGS. 3A to 3B). The thermal management apparatus 132, which may include logic instructions, configurable logic, fixed-functionality hardware logic, may be readily substituted for the agent 15 (FIG. 1), the agent 42 (FIGS. 4A and 4B), and/or the agent 52 (FIGS. 5A and 5B), already discussed. A behavior learner 132a may learn thermal behavior information of a system based on input information including one or more of processor information, thermal information, and cooling information. A parameter adjuster 132b may provide information to adjust one or more of a parameter of a processor (e.g., power, frequency, etc.) and a parameter of a cooling subsystem (e.g., power, fan speed, pump throughput, etc.) based on the learned thermal behavior information and the input information. In some embodiments, the input information may include reinforcement information, and the behavior learner 132a may be further configured to learn the thermal behavior information of the system based on the reinforcement information. For example, the reinforcement information may include one or more of reward information and penalty information. In some embodiments, the behavior learner 132a may be configured to learn the thermal behavior of the system based on adjustments to increase the reward information and decrease the penalty information. For example, increased reward information may correspond to one or more of increased processor frequencies and reduced active cooling, and increased penalty information may correspond to processor temperatures above a threshold temperature. In some embodiments, the behavior learner 132a may be further configured to provide a deep reinforcement learning agent with Q-learning.

Turning now to FIG. 6B, thermal management apparatus 134 (134a, 134b) is shown in which logic 134b (e.g., transistor array and other integrated circuit/IC components) is coupled to a substrate 134a (e.g., silicon, sapphire, gallium arsenide). The logic 134b may generally implement one or more aspects of the method 30 (FIGS. 3A to 3B). Thus, the logic 134b may include technology to learn thermal behavior information of a system based on input information including one or more of processor information, thermal information, and cooling information, and provide information to adjust one or more of a parameter of a processor (e.g., power, frequency, etc.) and a parameter of a cooling subsystem (e.g., power, fan speed, pump throughput, etc.) based on the learned thermal behavior information and the input information. In some embodiments, the input information may include reinforcement information, and the logic 134b may be further configured to learn the thermal behavior information of the system based on the reinforcement information. For example, the reinforcement information may include one or more of reward information and penalty information. In some embodiments, the logic 134b may be configured to learn the thermal behavior of the system based on adjustments to increase the reward information and decrease the penalty information. For example, increased reward information may correspond to one or more of increased processor frequencies and reduced active cooling, and increased penalty information may correspond to processor temperatures above a threshold temperature. In some embodiments, the logic 134b may be further configured to provide a deep reinforcement learning agent with Q-learning. In one example, the apparatus 134 is a semiconductor die, chip and/or package.

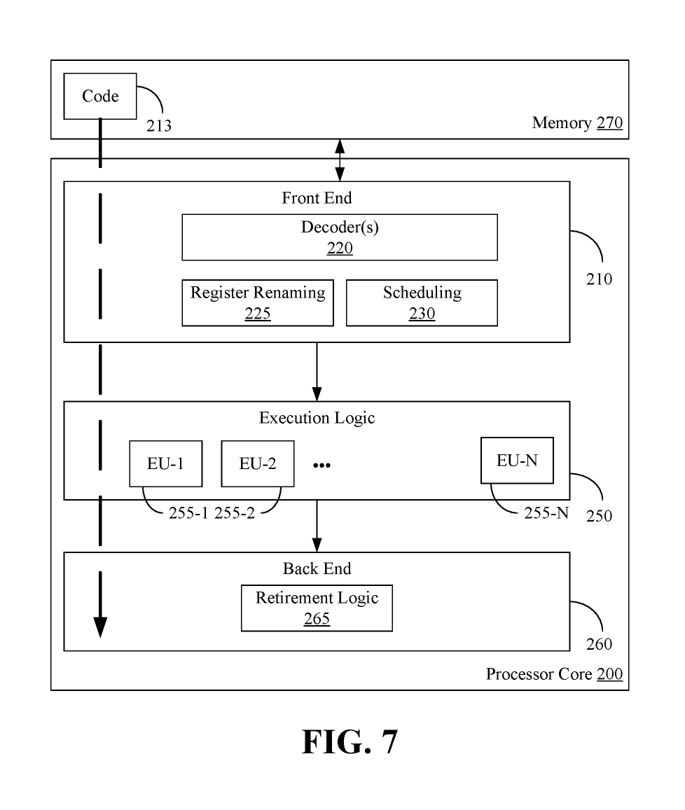

FIG. 7 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 7, a processing element may alternatively include more than one of the processor core 200 illustrated in FIG. 7. The processor core 200 may be a single-threaded core or, for at least one embodiment, the processor core 200 may be multithreaded in that it may include more than one hardware thread context (or “logical processor”) per core.

FIG. 7 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the method 30 (FIGS. 3A to 3B), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 7, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

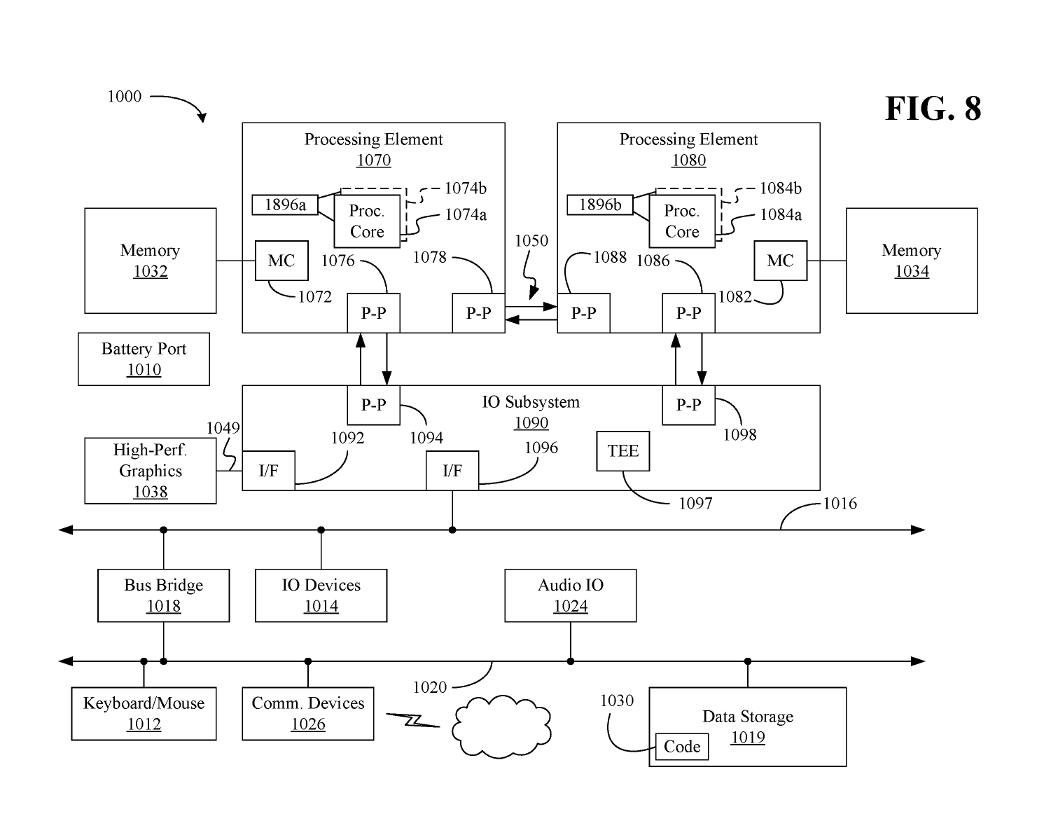

Referring now to FIG. 8, shown is a block diagram of a system 1000 embodiment in accordance with an embodiment. Shown in FIG. 8 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 8 may be implemented as a multi-drop bus rather than point-to-point interconnect.

As shown in FIG. 8, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 7.

Each processing element 1070, 1080 may include at least one shared cache 1896a, 1896b (e.g., static random access memory/SRAM). The shared cache 1896a, 1896b may store data (e.g., objects, instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2(L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 8, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 8, the I/O subsystem 1090 includes a TEE 1097 (e.g., security controller) and P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 8, various I/O devices 1014 (e.g., cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, network controllers/communication device(s) 1026 (which may in turn be in communication with a computer network), and a data storage unit 1019 such as a disk drive or other mass storage device which may include code 1030, in one embodiment. The code 1030 may include instructions for performing embodiments of one or more of the methods described above. Thus, the illustrated code 1030 may implement one or more aspects of the method 30 (FIGS. 3A to 3B), already discussed, and may be similar to the code 213 (FIG. 7), already discussed. Further, an audio I/O 1024 may be coupled to second bus 1020.

Note that other embodiments are contemplated. For example, instead of the point-to-point architecture of FIG. 8, a system may implement a multi-drop bus or another such communication topology.

Additional Notes and Examples:

Example 1 may include an electronic processing system, comprising a processor, memory communicatively coupled to the processor, a sensor communicatively coupled to the processor, a cooling subsystem communicatively coupled to the processor, and a machine learning agent communicatively coupled to the processor, the sensor, and the cooling subsystem, the machine learning agent including logic to learn thermal behavior information of the system based on information from one or more of the processor, the sensor, and the cooling subsystem, and adjust one or more of a parameter of the processor and a parameter of the cooling subsystem based on the learned thermal behavior information and information from one or more of the processor, the sensor, and the cooling subsystem.

Example 2 may include the system of Example 1, wherein the logic is further to learn the thermal behavior information of the system based on reinforcement information from one or more of the processor, the sensor, and the cooling subsystem.

Example 3 may include the system of Example 2, wherein the reinforcement information includes one or more of reward information and penalty information.

Example 4 may include the system of Example 3, wherein the logic is further to learn the thermal behavior of the system based on adjustments to increase the reward information and decrease the penalty information.

Example 5 may include the system of Example 4, wherein increased reward information corresponds to one or more of increased processor frequencies and reduced active cooling, and wherein increased penalty information corresponds to processor temperatures above a threshold temperature.

Example 6 may include the system of any of Examples 1 to 5, wherein the machine learning agent includes a deep reinforcement learning agent with Q-learning.

Example 7 may include a semiconductor package apparatus, comprising one or more substrates, and logic coupled to the one or more substrates, wherein the logic is at least partly implemented in one or more of configurable logic and fixed-functionality hardware logic, the logic coupled to the one or more substrates to learn thermal behavior information of a system based on input information including one or more of processor information, thermal information, and cooling information, and provide information to adjust one or more of a parameter of a processor and a parameter of a cooling subsystem based on the learned thermal behavior information and the input information.

Example 8 may include the apparatus of Example 7, wherein the input information further includes reinforcement information, wherein the logic is further to learn the thermal behavior information of the system based on the reinforcement information.

Example 9 may include the apparatus of Example 8, wherein the reinforcement information includes one or more of reward information and penalty information.

Example 10 may include the apparatus of Example 9, wherein the logic is further to learn the thermal behavior of the system based on adjustments to increase the reward information and decrease the penalty information.

Example 11 may include the apparatus of Example 10, wherein increased reward information corresponds to one or more of increased processor frequencies and reduced active cooling, and wherein increased penalty information corresponds to processor temperatures above a threshold temperature.

Example 12 may include the apparatus of any of Examples 7 to 11, wherein the logic is further to provide a deep reinforcement learning agent with Q-learning.

Example 13 may include the apparatus of any of Examples 7 to 12, wherein the logic coupled to the one or more substrates includes transistor channel regions that are positioned within the one or more substrates.

Example 14 may include a method of managing a thermal system, comprising learning thermal behavior information of a system based on input information including one or more of processor information, thermal information, and cooling information, and providing information to adjust one or more of a parameter of a processor and a parameter of a cooling subsystem based on the learned thermal behavior information and the input information.

Example 15 may include the method of Example 14, wherein the input information further includes reinforcement information, further comprising learning the thermal behavior information of the system based on the reinforcement information.

Example 16 may include the method of Example 15, wherein the reinforcement information includes one or more of reward information and penalty information.

Example 17 may include the method of Example 16, further comprising learning the thermal behavior of the system based on adjustments to increase the reward information and decrease the penalty information.

Example 18 may include the method of Example 17, wherein increased reward information corresponds to one or more of increased processor frequencies and reduced active cooling, and wherein increased penalty information corresponds to processor temperatures above a threshold temperature.

Example 19 may include the method of any of Examples 14 to 18, further comprising providing a deep reinforcement learning agent with Q-learning.

Example 20 may include at least one computer readable storage medium, comprising a set of instructions, which when executed by a computing device, cause the computing device to learn thermal behavior information of a system based on input information including one or more of processor information, thermal information, and cooling information, and provide information to adjust one or more of a parameter of a processor and a parameter of a cooling subsystem based on the learned thermal behavior information and the input information.

Example 21 may include the at least one computer readable storage medium of Example 20, wherein the input information further includes reinforcement information, comprising a further set of instructions, which when executed by the computing device, cause the computing device to learn the thermal behavior information of the system based on the reinforcement information.

Example 22 may include the at least one computer readable storage medium of Example 21, wherein the reinforcement information includes one or more of reward information and penalty information.

Example 23 may include the at least one computer readable storage medium of Example 22, comprising a further set of instructions, which when executed by the computing device, cause the computing device to learn the thermal behavior of the system based on adjustments to increase the reward information and decrease the penalty information.

Example 24 may include the at least one computer readable storage medium of Example 23, wherein increased reward information corresponds to one or more of increased processor frequencies and reduced active cooling, and wherein increased penalty information corresponds to processor temperatures above a threshold temperature.

Example 25 may include the at least one computer readable storage medium of any of Examples 20 to 24, comprising a further set of instructions, which when executed by the computing device, cause the computing device to provide a deep reinforcement learning agent with Q-learning.

Example 26 may include a thermal management apparatus, comprising means for learning thermal behavior information of a system based on input information including one or more of processor information, thermal information, and cooling information, and means for providing information to adjust one or more of a parameter of a processor and a parameter of a cooling subsystem based on the learned thermal behavior information and the input information.

Example 27 may include the apparatus of Example 26, wherein the input information further includes reinforcement information, further comprising means for learning the thermal behavior information of the system based on the reinforcement information.

Example 28 may include the apparatus of Example 27, wherein the reinforcement information includes one or more of reward information and penalty information.

Example 29 may include the apparatus of Example 28, further comprising means for learning the thermal behavior of the system based on adjustments to increase the reward information and decrease the penalty information.

Example 30 may include the apparatus of Example 29, wherein increased reward information corresponds to one or more of increased processor frequencies and reduced active cooling, and wherein increased penalty information corresponds to processor temperatures above a threshold temperature.

Example 31 may include the apparatus of any of Examples 26 to 30, further comprising means for providing a deep reinforcement learning agent with Q-learning.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An electronic processing system, comprising:
a processor;
memory communicatively coupled to the processor;
a sensor communicatively coupled to the processor;
a cooling subsystem communicatively coupled to the processor; and
a machine learning agent communicatively coupled to the processor, the sensor, and the cooling subsystem, the machine learning agent including logic to:
learn thermal behavior information of the system based on information from one or more of the processor, the sensor, and the cooling subsystem, and
adjust one or more of a parameter of the processor and a parameter of the cooling subsystem based on the learned thermal behavior information and information from one or more of the processor, the sensor, and the cooling subsystem.

2. The system of claim 1, wherein the logic is further to:
learn the thermal behavior information of the system based on reinforcement information from one or more of the processor, the sensor, and the cooling subsystem.

3. The system of claim 2, wherein the reinforcement information includes one or more of reward information and penalty information.

4. The system of claim 3, wherein the logic is further to:
learn the thermal behavior of the system based on adjustments to increase the reward information and decrease the penalty information.

5. The system of claim 4, wherein increased reward information corresponds to one or more of increased processor frequencies and reduced active cooling, and wherein increased penalty information corresponds to processor temperatures above a threshold temperature.

6. The system of claim 1, wherein the machine learning agent includes a deep reinforcement learning agent with Q-learning.

7. A semiconductor package apparatus, comprising:
one or more substrates; and
logic coupled to the one or more substrates, wherein the logic is at least partly implemented in one or more of configurable logic and fixed-functionality hardware logic, the logic coupled to the one or more substrates to:
learn thermal behavior information of a system based on input information including one or more of processor information, thermal information, and cooling information, and
provide information to adjust one or more of a parameter of a processor and a parameter of a cooling subsystem based on the learned thermal behavior information and the input information.

8. The apparatus of claim 7, wherein the input information further includes reinforcement information, wherein the logic is further to:
learn the thermal behavior information of the system based on the reinforcement information.

9. The apparatus of claim 8, wherein the reinforcement information includes one or more of reward information and penalty information.

10. The apparatus of claim 9, wherein the logic is further to:
learn the thermal behavior of the system based on adjustments to increase the reward information and decrease the penalty information.

11. The apparatus of claim 10, wherein increased reward information corresponds to one or more of increased processor frequencies and reduced active cooling, and wherein increased penalty information corresponds to processor temperatures above a threshold temperature.

12. The apparatus of claim 7, wherein the logic is further to:
provide a deep reinforcement learning agent with Q-learning.

13. The apparatus of claim 7, wherein the logic coupled to the one or more substrates includes transistor channel regions that are positioned within the one or more substrates.

14. A method of managing a thermal system, comprising:
learning thermal behavior information of a system based on input information including one or more of processor information, thermal information, and cooling information; and
providing information to adjust one or more of a parameter of a processor and a parameter of a cooling subsystem based on the learned thermal behavior information and the input information.

15. The method of claim 14, wherein the input information further includes reinforcement information, further comprising:
learning the thermal behavior information of the system based on the reinforcement information.

16. The method of claim 15, wherein the reinforcement information includes one or more of reward information and penalty information.

17. The method of claim 16, further comprising:
learning the thermal behavior of the system based on adjustments to increase the reward information and decrease the penalty information.

18. The method of claim 17, wherein increased reward information corresponds to one or more of increased processor frequencies and reduced active cooling, and wherein increased penalty information corresponds to processor temperatures above a threshold temperature.

19. The method of claim 14, further comprising:
providing a deep reinforcement learning agent with Q-learning.

20. At least one computer readable storage medium, comprising a set of instructions, which when executed by a computing device, cause the computing device to:
learn thermal behavior information of a system based on input information including one or more of processor information, thermal information, and cooling information; and
provide information to adjust one or more of a parameter of a processor and a parameter of a cooling subsystem based on the learned thermal behavior information and the input information.

21. The at least one computer readable storage medium of claim 20, wherein the input information further includes reinforcement information, comprising a further set of instructions, which when executed by the computing device, cause the computing device to:
learn the thermal behavior information of the system based on the reinforcement information.

22. The at least one computer readable storage medium of claim 21, wherein the reinforcement information includes one or more of reward information and penalty information.

23. The at least one computer readable storage medium of claim 22, comprising a further set of instructions, which when executed by the computing device, cause the computing device to:
learn the thermal behavior of the system based on adjustments to increase the reward information and decrease the penalty information.

24. The at least one computer readable storage medium of claim 23, wherein increased reward information corresponds to one or more of increased processor frequencies and reduced active cooling, and wherein increased penalty information corresponds to processor temperatures above a threshold temperature.

25. The at least one computer readable storage medium of claim 20, comprising a further set of instructions, which when executed by the computing device, cause the computing device to:
provide a deep reinforcement learning agent with Q-learning.
